(19) United States
(12) Patent Application Publication
(10) Pub. No.: US 2025/0192147 A1
(43) Pub. Date: Jun. 12, 2025

(54) LAYERED CATHODE

(71) Applicant: FORD GLOBAL TECHNOLOGIES, LLC, Dearborn, MI (US)

(72) Inventors: Mihir UPADHYE, Ann Arbor, MI (US); Celia CUNNINGHAM, Detroit, MI (US); Zijie LU, Novi, MI (US)

(21) Appl. No.: 18/535,496

(22) Filed: Dec. 11, 2023

(51) Int. Cl. H01M 4/36; H01M 4/04; H01M 4/131; H01M 4/485; H01M 4/505; H01M 4/525; H01M 10/0525; H01M 10/0562

(52) U.S. Cl. CPC H01M 4/366; H01M 4/0404; H01M 4/131; H01M 4/485; H01M 4/505; H01M 4/525; H01M 10/0525; H01M 10/0562

(57) ABSTRACT

A battery electrode for solid-state battery cells and a method for its fabrication are provided. The electrode comprises two layers, an ion transport layer comprising a homogeneous mixture of lithium argyrodite and lithium ceramic coated nickel manganese cobalt oxide particles, and an electron transport layer with uncoated nickel manganese cobalt oxide particles. The electron transport layer may include lithium argyrodite particles in a specific ratio and may be sulfide-based.

### TECHNICAL FIELD

This disclosure relates to a cathode structure for solid-state battery cells.

### BACKGROUND

In the field of energy storage, sulfide-based solid-state batteries (SSBs) with nickel manganese cobalt (NMC)-based cathodes are used due to their energy density, thermal stability, specific capacity, and performance at high voltages in lithium-ion batteries. However, cathodes used in SSBs containing a lithium argyrodite (Li₆PS₅Cl or LPSC) sulfide solid electrolyte can react with NMC, leading to the formation of resistive interfacial layers. These layers may cause capacity fading during the initial charge or discharge cycles.

For conventional lithium-ion batteries, the addition of carbon additives to the cathode is a recognized approach to increase electrical conductivity. Extending this concept to NMC cathodes in sulfide-based SSBs, carbon additives have been considered to enhance conductivity. However, this solution introduces a new issue. The carbon additives tend to react with LPSC particles, affecting the LPSC. This reaction may contribute to capacity fade and reduced cycle life.

### SUMMARY

A battery electrode comprises a homogeneous layer of lithium argyrodite particles and nickel manganese cobalt oxide (NMC) particles, coated with lithium ceramic to form an ion transport layer, and an additional layer of uncoated NMC particles defining an electron transport layer, creating a cathode when in contact with the ion transport layer. The electron transport layer may be sulfide-based or include lithium argyrodite particles. In one embodiment, the ratio of lithium argyrodite to uncoated NMC particles is approximately 10:90. The electron transport layer may further comprise carbon additives, and the lithium ceramic coating on NMC particles may be either Li₄Ti₅O₁₂ or LiNbO₃.

A method for forming a cathode involves applying and curing a homogeneous slurry of lithium argyrodite and NMC particles, followed by a layer of uncoated NMC particles, onto a current collector. The lithium ceramic coating on NMC particles in the method may be applied using a sol-gel process and may use Li₄Ti₅O₁₂ or LiNbO₃. The slurry applied to the homogeneous layer may have a specific ratio of lithium argyrodite to NMC particles, around 10:90.

A solid-state battery cell comprising an anode, a cathode with distinct ion and electron conducting layers, and a solid electrolyte between the anode and the ion conducting layer is described. The battery cell may include a pair of current collectors sandwiching the anode, solid electrolyte, and cathode. The electron conducting layer may contain carbon additives, be sulfide-based, or include lithium argyrodite particles and uncoated NMC particles, with a specific ratio of approximately 10:90 for lithium argyrodite to uncoated NMC particles. The ion conducting layer may include lithium ceramic coated NMC particles, comprising a homogeneous mixture of lithium argyrodite particles and lithium ceramic coated NMC particles, and the lithium ceramic coated NMC particles may be coated with either Li₄Ti₅O₁₂ or LiNbO₃.

### BRIEF DESCRIPTION OF THE DRAWINGS

FIG. 1 is a schematic view of a battery cell according to one embodiment;

FIG. 2 is a schematic view of a battery electrode according to one embodiment; and

FIG. 3. is a flowchart of an assembly process according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure relates to the assembly and composition of sulfide-based solid-state batteries (SSBs) specifically the cathode composition and design. Sulfide-based SSBs, utilizing layered oxide LiNiₓMn_{y}Co_{1-x-y}O₂ (NMC) as a cathode material, may have potential advantages over conventional lithium-ion batteries, particularly in terms of energy density. However, when NMC is used with sulfide-based lithium argyrodite (Li₆PS₅Cl, or LPSC) as the solid electrolyte, the instability of LPSC in the presence of NMC leads to side reactions that may diminish the effectiveness of NMC in lithium-ion intercalation and create byproducts at the cathode and separator interface.

A cathode structure comprising two distinct layers is proposed. A first layer, referred to as the ion transport layer, is positioned at the interface between the cathode and the solid electrolyte. This layer may comprise a homogeneous mixture of NMC and LPSC particles, potentially in a 50:50 ratio. The NMC particles in this layer may be coated with a lithium-containing material, such as Li₂O-based solid solutions, Li₄Ti₅O₁₂, or LiNbO₃, applied through a sol-gel process. This coating may facilitate lithium-ion conduction while preventing electron conduction.

The ion transport layer comprises large NMC particle sizes (approximately 10 μm mean particle diameter) compared to a second layer. This size difference is intended to facilitate lithium-ion diffusion into a cathode, theoretically increasing the energy density and output of a battery. A second layer, known as the electron transport layer, is situated between the current collector and the ion transport layer. The electron transport layer may comprise NMC and LPSC particles in a 90:10 ratio. The reduced presence of LPSC in this layer may allow for the stable inclusion of carbon additives, which are mixed with the NMC particles to increase electrical conductivity at the cathode and current collector interface. These additives may help to increase a battery's charging rate. In this layer, the NMC particles are generally uncoated to maintain electrical conductivity, which may be a consideration for direct current (DC) fast charging applications.

The layered cathode composition may be assembled through two sequential slot die coating operations. The first operation involves coating the electron transport layer onto the current collector, followed by the application of the ion transport layer onto the electron transport layer.

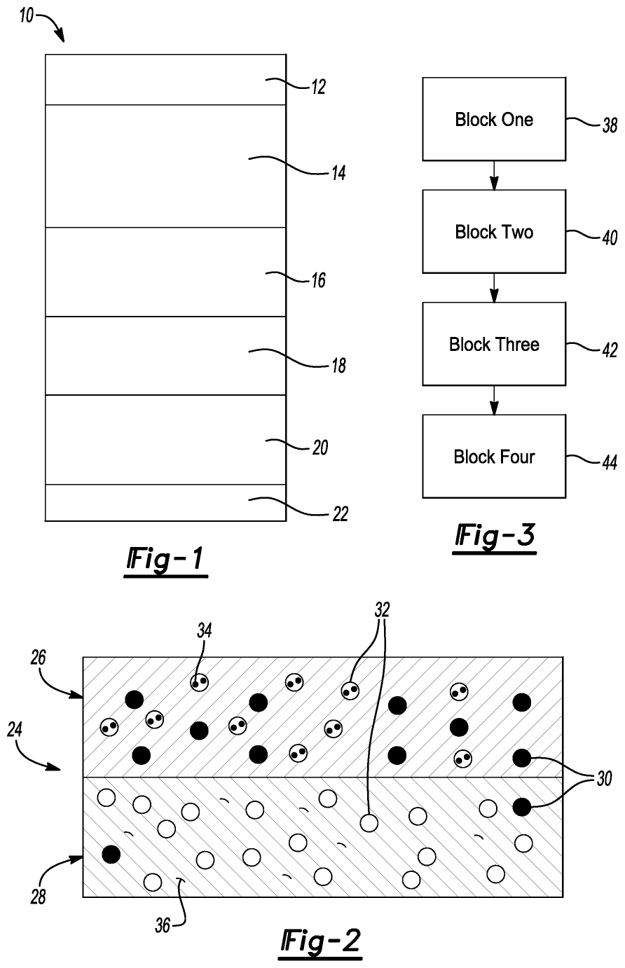

FIG. 1 illustrates a schematic view of a solid-state battery cell 10, according to one embodiment. At the topmost section of battery cell 10 is an anode current collector 12. The anode current collector 12 facilitates the collection and distribution of electrons at an anode end during charging and discharging cycles. The design of the anode current collector 12 is optimized for efficient electron flow, contributing to the overall performance of the battery. Directly beneath the anode current collector 12 is an anode 14. The anode layer 14 houses lithium ions during the battery's discharge phase, thus influencing the energy capacity of battery cell 10. Under the anode layer 14 is a solid electrolyte 16, which is a sulfide-based solid electrolyte, situated between the anode 14 and the ion-conducting layer 18, in direct contact. The solid electrolyte 16 facilitates ion conduction while simultaneously preventing electron flow.

An ion-conducting layer 18 comprises a homogeneous mixture or a 50:50 ratio of lithium argyrodite particles to lithium nickel manganese cobalt oxide particles. Wherein the nickel manganese cobalt oxide particles may be coated with a lithium ceramic, such as Li₄Ti₅O₁₂ or LiNbO3. This forms the homogenous layer defining the ion transport layer 18. The ion conducting layer 18 facilitates the movement of lithium ions within battery cell 10. Beneath the ion-conducting layer 18 is the electron conducting layer 20. The adjacent electron conducting layer 20 comprises a 10:90 ratio of lithium argyrodite particles to uncoated nickel manganese cobalt oxide particles. The electron conducting layer 20 may also include carbon additives. The electron-conducting layer 20 facilitates electron conduction. A cathode current 22 is positioned at the bottom of the battery cell 10. The cathode current collector facilitates the external flow of electrons, completing the battery cell's electrical circuit. The solid-state battery cell 10 is sandwiched between the pair of current collectors 12 and 22, with the anode current collector 12 at the top and the cathode current collector 22 at the bottom.

FIG. 2 illustrates a schematic view of a battery electrode 24. The battery electrode 24 has an ion transport layer 26 atop an electron transport layer 28. The respective layers contain particles of lithium argyrodite 30 and nickel manganese cobalt oxide (NMC) 32. The ion transport layer 26 comprises a homogeneous mixture of lithium argyrodite particles 30 and NMC 32 particles. In the ion transport layer 26 the nickel manganese cobalt oxide particles 32 may be coated with a lithium ceramic 34. The lithium ceramic coating 34 may be either Li₄Ti₅O₁₂ or LiNbO₃. The electron transport layer 28 having a different material composition than the ion transport layer 26 comprises a ratio of the lithium argyrodite particles 30 to the NMC particles 32 that are uncoated of about 10:90 The electron transport layer 28 may be sulfide-based. In some configurations the electron transport layer 28 may contain a carbon additive 36.

FIG. 3 is an illustration of a flowchart of an assembly process according to one embodiment. In Block One 38, a homogenous slurry is prepared, comprising lithium argyrodite particles and nickel manganese cobalt oxide (NMC) particles. The NMC particles in this slurry may be coated with a lithium ceramic, which could be either Li₄Ti₅O₁₂ or LiNbO₃. This slurry is then uniformly applied to a current collector. After applying the slurry in Block Two 40, the slurry undergoes a curing process. Curing solidifies the slurry into a homogenous layer adhering to the current collector. This layer serves as a base layer for the subsequent step.

In Block Three 42 a second slurry is applied. This slurry comprises uncoated NMC particles. The ratio of lithium argyrodite to NMC particles in this slurry may be around 10:90. In Block Four 44, this second slurry layer is also subjected to a curing process. This step solidifies the layer and integrates it with the underlying homogenous layer. The result is bilayer cathode. The coating of the NMC particles with lithium ceramic, may be done via a sol-gel process. Suitable lithium ceramics may be either Li₄Ti₅O₁₂ or LiNbO₃.

The algorithms, methods, or processes disclosed or suggested herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery electrode comprising:
a homogeneous layer of lithium argyrodite particles and nickel manganese cobalt oxide particles that are coated with a lithium ceramic defining an ion transport layer; and
a layer including nickel manganese cobalt oxide particles that are uncoated defining an electron transport layer in contact with the ion transport layer to form a cathode.

2. The battery electrode of claim 1 wherein the electron transport layer is sulfide-based.

3. The battery electrode of claim 1 wherein the electron transport layer includes lithium argyrodite particles.

4. The battery electrode of claim 3 wherein a ratio of the lithium argyrodite particles to the nickel manganese cobalt oxide particles that are uncoated is about 10:90.

5. The battery electrode of claim 1 wherein the electron transport layer further comprises carbon additives.

6. The battery electrode of claim 1 wherein the nickel manganese cobalt oxide particles that are coated with a lithium ceramic are coated with either Li₄Ti₅O₁₂ or LiNbO₃.

7. A method comprising:
applying a homogeneous slurry of lithium argyrodite particles and nickel manganese cobalt oxide particles that are coated with a lithium ceramic to a current collector;
curing the homogenous slurry to form a homogenous layer;
applying a slurry including nickel manganese cobalt oxide particles that are uncoated to the homogenous layer; and
curing the slurry to form a cathode.

8. The method of claim 7 further comprising coating nickel manganese cobalt oxide particles with a lithium ceramic via a sol-gel process to form the nickel manganese cobalt oxide particles that are coated with the lithium ceramic.

9. The method of claim 7 wherein the lithium ceramic is either Li₄Ti₅O₁₂ or LiNbO₃.

10. The method of claim 7 wherein the slurry including nickel manganese cobalt oxide particles that are uncoated further comprises a ratio of lithium argyrodite particles to the nickel manganese cobalt oxide particles of about 10:90.

11. A solid-state battery cell comprising:
an anode;
a cathode including an ion conducting layer and an adjacent electron conducting layer having a material composition different than the ion conducting layer; and
a solid electrolyte between and in direct contact with the anode and the ion conducting layer such that the ion conducting layer is between the solid electrolyte and the electron conducting layer.

12. The solid-state battery cell of claim 11 wherein the anode, solid electrolyte, and cathode are sandwiched between a pair of current collectors.

13. The solid-state battery cell of claim 11 wherein the electron conducting layer further comprises carbon additives.

14. The solid-state battery cell of claim 11 wherein the electron conducting layer is sulfide-based.

15. The solid-state battery cell of claim 14 wherein the electron conducting layer includes lithium argyrodite particles.

16. The solid-state battery cell of claim 15 wherein the electron conducting layer includes uncoated nickel manganese cobalt oxide particles.

17. The solid-state battery cell of claim 16 wherein a ratio of the lithium argyrodite particles to the uncoated nickel manganese cobalt oxide particles is about 10:90.

18. The solid-state battery cell of claim 11 wherein the ion conducting layer includes lithium ceramic coated nickel manganese cobalt oxide particles.

19. The solid-state battery cell of claim 18 wherein the ion conducting layer comprises a homogeneous mixture of lithium argyrodite particles and the lithium ceramic coated nickel manganese cobalt oxide particles.

20. The solid-state battery cell of claim 18 wherein the lithium ceramic coated nickel manganese cobalt oxide particles are coated with either Li₄Ti₅O₁₂ or LiNbO₃.
